(19) United States
(12) Patent Application Publication
(10) Pub. No.: US 2006/0085619 A1
(43) Pub. Date: Apr. 20, 2006

(54) Apparatus and method for self-reconstructing system operating data

(75) Inventor: Young-Mi Jang, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/133,042

(22) Filed: May 19, 2005

(30) Foreign Application Priority Data
Sep. 24, 2004 (KR) 2004-0076872

(51) Int. Cl. G06F 12/14

(52) U.S. Cl. 711/173

(57) ABSTRACT

An apparatus and method for self-reconstructing system operating data in a mobile communication terminal is provided. The system operating data is stored in a hidden area of nonvolatile memory in the mobile communication terminal. The hidden area is read-only and its contents are periodically compared to the system operating data stored in an EFS area. If there is a difference, indicating the operating data in the EFS has changed, the original system operating data is copied from the hidden area. Thus, the reliability of the mobile communication terminal is improved and the integrity of the mobile communication terminal is maintained.

### PRIORITY

This application claims priority under 35 U.S.C. § 119 to an application entitled “Apparatus And Method For Self-Reconstructing Of System Operating Data” filed in the Korean Intellectual Property Office on Sep. 24, 2004 and assigned Serial No. 2004-0076872, the contents of which are incorporated herein by reference.

### BACKGROUND OF THE INVENTION

1. Field of the Invention

The present invention relates to a mobile communication system, and more particularly, to an apparatus and method for self-reconstructing a system operating data, in which data stored in a memory of a mobile communication terminal can be preserved and any lost data can be reconstructed.

2. Background of the Prior Art

Recent advancements in mobile communication technology allows a variety of functions to be provided in a mobile communication terminal besides simple voice communication. Specifically, digital convergence makes a variety of functions merge in a mobile communication terminal. Since more and more of the digital functions are included and used in mobile communication terminals, a reliable memory has become an important factor.

If the operation of the memory fails, fatal problems such as a system crash may result.

A typical fatal problem is an error or loss of data of nonvolatile (NV) information stored in a system file. That is, if calibration or setup and configuration data is lost, the performance of the mobile communication terminal may degrade or in the terminal may crash permanently or not work properly. This start-up and configuration data is necessary for operation of the mobile communication terminal.

Flash memory is a nonvolatile memory and is classified into NOR type and NAND type. The NOR flash memory is superior to the NAND flash memory with faster access and better reliability. However, the NAND flash memory is preferred because the NOR flash memory is expensive, making it difficult to implement a large capacity storage.

An inexpensive NOR flash memory has been developed recently so the use of NOR flash memory is expected to rise. Whichever memory is used, repeated read and write operations eventually degrade the memory, wearing it down and making it more susceptible to failure and data loss.

In mobile communication terminals with a NOR flash memory, the nonvolatile item is stored in an embedded file system (EFS) as a system file. The terminal uses data stored in the memory, but when data is modified, the entire sector on which it resides becomes unusable, even if only a part of the data is changed. The newly modified data is moved to another sector for storage.

The mobile communication terminal periodically performs a clean-up function on the unusable regions when the amount of unusable space reaches a certain threshold, thereby securing a storage area of a memory.

FIG. 1 illustrates a memory map of a mobile communication terminal according to the prior art.

Referring to FIG. 1, a memory of a mobile communication terminal is divided into

Referring to FIG. 1, a memory of a mobile communication terminal is divided into a binary area and an EFS area. The binary area stores an executable file of the mobile communication terminal. The EFS area stores system files. The mobile communication terminal reads system files from the EFS area required by the executable file.

To execute a program, a nonvolatile memory of the mobile communication terminal copies the file from the EFS area into the region with the executable file. In general, the EFS area is configured with 64k sectors.

When modifying data stored in the EFS area, the mobile communication terminal does not modify a portion of the EFS area, but erases and rewrites an entire sector where the modified data is stored.

At this point, the mobile communication terminal applies a very high voltage to a cell to execute a program, usually requiring an erase operation and a read operation. If these procedures are repeated many times, a defect may occur in a specific section of the flash memory and thus the system file may be damaged. In addition, data may be lost during the repetitive disk cleanup.

The configuration data that is set for the terminal optimization is stored in the EFS area according to the file system format. In general, the configuration data is divided into 5 to 10 files. The configuration data of each terminal reflects the maximum operating ability of each terminal. If the configuration data is not maintained, a terminal cannot be configured correctly.

When data is modified, the file is marked as unusable in the file header. The new modified file is created at another sector and the unusable file is classified as garbage. If the amount of unusable files reaches a predetermined level, memory is rearranged by a collection and reorganization method similar to a disk defragment of a personal computer (PC).

If these cleanup procedures are repeated many times, a random access memory (RAM) may operate abnormally, or the configuration data stored on the RAM may be lost during the cleanup process. In addition, a specific section of the flash memory may become defective and cause data loss.

### SUMMARY OF THE INVENTION

Accordingly, the present invention is directed to an apparatus and method for self-reconstructing data that addresses the problems, limitations and disadvantages of the prior art.

An object of the present invention is to provide an apparatus and method for self-reconstructing loss of data stored in a nonvolatile memory.

To achieve the object and other advantages, according to one embodiment of the present invention, a nonvolatile memory for a reconstruction of a system operating data includes: an EFS (embedded file system) area including a data area storing a first system operating data and a hidden area storing a second system operating data and allowing only a read access; and a binary area storing an algorithm that periodically compares the first system operating data stored in the data area and the second system operating data stored in the hidden area.

The data area allows both a read access and a write access. If the first system operating data stored in the data area is different from the second system operating data stored in the hidden area, the system operating data stored in the hidden area is overwritten onto the EFS area.

According to another embodiment of the present invention, a method for reconstructing data in a mobile communication terminal includes the steps of: allocating a hidden area at a nonvolatile memory; storing a system operating data in a data area and the hidden area; and periodically comparing whether or not the system operating data stored in the data area is equal to the system operating data stored in the hidden area.

The method may further include the step of overwriting the system operating data stored in the hidden area onto the data area, if the first system operating data stored in the EFS area is different from the second system operating data stored in the hidden area.

The hidden area allows only a read access, and the data area allows both a read access and a write access.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a memory map of a mobile communication terminal according to the prior art;

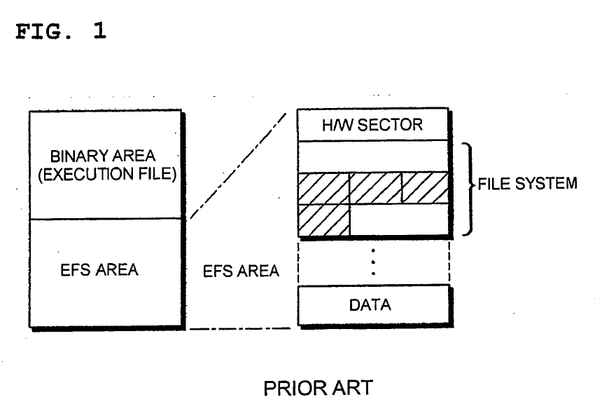

FIG. 2 is a block diagram of a mobile communication terminal according to the present invention;

FIG. 3 illustrates a memory map of a mobile communication terminal according to the present invention; and

FIG. 4 is a flowchart illustrating a method for reconstructing a lost data of a mobile communication terminal according to the present invention.

### DETAILED DESCRIPTION OF THE PREFERRED EMBODIMENTS

Reference will now be made in detail to the preferred embodiments of the present invention, examples of which are illustrated in the accompanying drawings. Also, when it is determined that the subject of the invention may be ambiguous by a detailed description, the detailed description will be omitted.

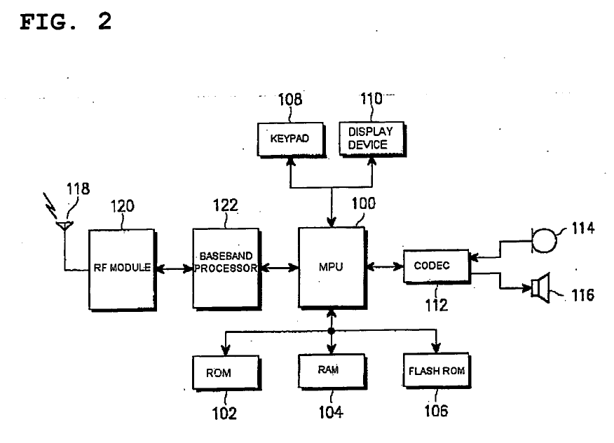

FIG. 2 is a block diagram of a mobile communication terminal according to the present invention.

A mobile communication terminal which will be described below includes a cellular phone, a personal communication system (PCS), a personal data assistant (PDA), an international mobile communication 2000 (IMT-2000) terminal, and the like. Hereinafter, a description will be made with a general structure of the above terminals.

Referring to FIG. 2, a microprocessor unit (MPU) 100 controls an overall operation of a mobile communication terminal. For example, the MPU 100 processes and controls voice communication and data communication. In addition to the typical functions, the MPU 100 allocates a hidden area within a nonvolatile memory and periodically checks whether to reconstruct data. A description about the typical process and control operation of the MPU 100 will be omitted.

A read only memory (ROM) 102 stores a variety of reference data and microcodes of a program for the process and control operation of the MPU 100. Since the ROM 102 is a nonvolatile memory, the ROM 102 can retain data regardless of a power supply. Flash memory is the most widely used type of nonvolatile memory.

A flash memory according to the present invention includes a binary area and an embedded file system (EFS) area. The binary area stores an executable file and the EFS area stores a file system and data. In addition, the flash memory further includes a hidden area within the EFS area.

A random access memory (RAM) 104 is a working memory of the MPU 100 and a volatile memory. The RAM 104 stores temporary data created during the execution of various programs. As described above, a flash ROM 106 is a nonvolatile memory and acts as a database, like a phone book, which stores various updateable data.

A key pad 108 includes numeric keys of digits 0 to 9 and a plurality of function keys, such as a MENU key, a CANCEL (DELETE) key, an ENTER key, a TALK key, an END key, an Internet connection key, navigation keys (up/down/right/left), and so on.

The four navigation keys are used as hot keys, which allow specific menu items [e.g., a message management (←), a phone book (→), a top-level menu list (↑) and a music box (↓)] to be directly entered. In general, the terminal has two keys (a menu key and a navigation key) for entering the top-level menu list.

A display device 110 displays status information, characters, images, and so on. A color liquid crystal display (LCD) may be used as the display device 110.

A coder-decoder (CODEC) 112 connected to the MPU 100, a microphone 114 and a speaker 116 connected to the CODEC 112 are an audio input/output block that is used for a telephone communication and voice recording. The MPU 100 produces PCM data and the CODEC 112 converts the PCM data into analog audio signals. The analog audio signals are outputted through the speaker 116. Also, the CODEC 112 converts audio signals received through the microphone 114 into PCM data and provides the PCM data to the MPU 100.

A radio frequency (RF) module 120 drops a frequency of an RF signal received through an antenna 118 and provides the RF signal to a baseband processor 122. Also, the RF module 120 increases a frequency of a baseband signal provided from the baseband processor 122 and transmits the baseband signal through the antenna 118. The baseband processor 122 processes the baseband signals that are transmitted/received between the RF module 120 and the MPU 100.

For example, in the case of data transmission, the baseband processor 122 performs a channel coding and spreading on the transmitting data. In the case of the data reception, the baseband processor 122 performs a despreading and channel decoding on the receiving data.

That is, the baseband processor 122 decodes a variety of channels (call channel, traffic channel, and so on) that are received from a base station, or generates a variety of channels (access channel, traffic channels, and so on) that are to be transmitted to the base station.

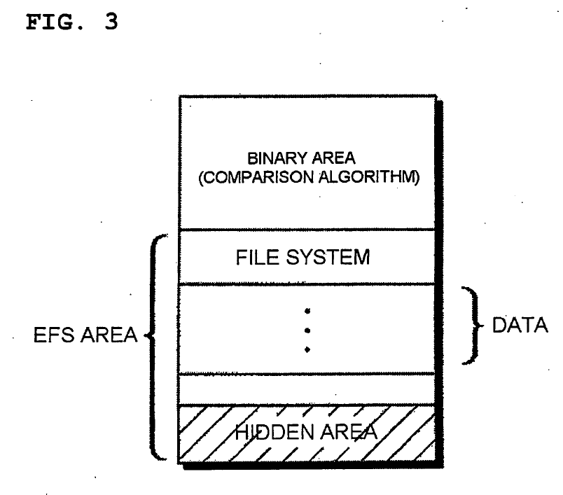

FIG. 3 illustrates a memory map of the mobile communication terminal according to the present invention.

Referring to FIG. 3, the nonvolatile memory of the mobile communication terminal is divided into two areas, that is, the EFS area and the binary area. The EFS area stores a file system data, a nonvolatile item file of the terminal, and so on. The nonvolatile item file includes system operating data having preset values that are necessary for the system operation. A typical example is calibration or configuration data. Accordingly, the EFS area includes a file system data area and the system operating data area (hereinafter called ‘data area’).

The EFS area according to the present invention further includes a hidden area, in addition to the file system data area and the system operating data area. The hidden area allows only a read access to original system operating data. The hidden area stores the system operating data so as to prevent data error that may occur during the read/write operations.

The binary area according to the present invention includes an algorithm that periodically compares the system operating data of the EFS area with the system operating data of the hidden area.

As described above, in order to execute the desired program, the nonvolatile memory of the mobile communication terminal loads the file system of the EFS system into the binary area where the executable file exists.

When modifying the data stored in the EFS area, the mobile communication terminal does not modify some of the EFS area, but erases and rewrites the entire sector where the data to be modified is stored.

At this point, the mobile communication terminal applies a very high voltage to a cell. If these procedures are repeated many times, a defect may occur in a specific section of the flash memory and thus the system file may be damaged. Also, data may be lost during repeated cleanup processes.

According to the present invention, the hidden area is separately allocated within the EFS area of the nonvolatile memory. The hidden area stores the system operating data as the values that are necessary for the system operation of the mobile communication terminal. The system operating data includes values associated with RF, Rx, Tx, a local oscillator, and so on.

That is, system operating data is stored in the data area of EFS area, and the system operating data is also stored in the hidden area. At this point, it should be noted that the hidden area is read-only.

Accordingly, the hidden area according to the present invention is not accessed for cleanup, preventing degradation of the flash memory integrity and abnormal operation of the RAM.

In addition, the binary area according to the present invention further includes an algorithm that periodically compares the system operating data of the data area of the EFS area with the system operating data of the hidden area.

The mobile communication terminal according to the present invention periodically compares the system operating data stored in the data area with the system operating data stored in the hidden area. If the two data are different from each other, the system operating data stored in the data area is erased and the data stored in the hidden area is read out and overwritten onto the data area.

In this manner, a calibration or configuration data of the data area is updated with the calibration or configuration data of the hidden area, which is the initial configuration data with original operating parameters. Thus, the mobile communication terminal can maintain the initial, optimal operation status.

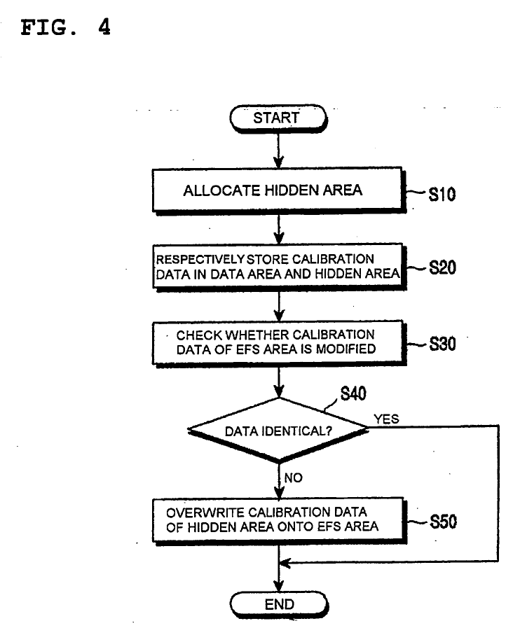

FIG. 4 is a flowchart illustrating a method for reconstructing lost data of the mobile communication terminal according to an embodiment of the present invention.

The mobile communication terminal allocates the read-only hidden area in the nonvolatile memory at step S10.

The system operating data is stored in the hidden area at step S20. The configuration data is typical system operating data that can be stored in the hidden area. The configuration data stored in the hidden area has the original values or operating parameters for the mobile communication terminal.

The configuration data necessary for the system operation is stored in the data area of the EFS area. Thus, the same configuration data is stored in the hidden area and the data area, respectively at step S20.

The mobile communication terminal checks whether the data stored in the data area is modified by periodically comparing the data stored in the data area with the data stored in the hidden area at step S30.

At step S40, it is determined whether the data in the data area is identical to the data in the hidden area. If the two are identical, it indicates that the data stored in the data area has not been modified. As described above, since the hidden area stores initial values and is read-only, its contents cannot be modified, preserving the integrity of the memory.

Accordingly, the data stored in the hidden area maintains its initial, original state. However, in the data area, the data modification and, thus, memory errors may occur during read/write operations.

Consequently, if the configuration data stored in the data area and the hidden area are not identical to each other, it indicates that the calibration data stored in the data area was modified. If that happens, the mobile communication terminal can reconstruct the original data area data using the configuration data of the hidden area, which maintains its initial set values.

That is, when the configuration data stored in the data area is modified, the mobile communication terminal erases the configuration data stored in the data area and overwrites it with the configuration data in the hidden at step S50.

Thus, the calibration data stored in the data area is updated with the calibration data of the hidden area, which is the initial set value, and the mobile communication terminal can maintain its original, initial, optimal state.

As described above, the loss of system operating data stored in the nonvolatile memory of a mobile communication terminal can be reconstructed. Thus, reliability of the terminal is improved and the integrity of the mobile terminal can be maintained regardless of the occurrence of serious error.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A nonvolatile memory for reconstruction of system operating data, the nonvolatile memory comprising:
an embedded file system (EFS) area including a data area storing a first system operating data and a hidden area storing a second system operating data and allowing only a read access; and
a binary area storing an algorithm that periodically compares the first system operating data stored in the data area and the second system operating data stored in the hidden area.

2. The nonvolatile memory of claim 1, wherein the data area allows both a read access and a write access.

3. The nonvolatile memory of claim 1, wherein if the first system operating data stored in the data area is different from the second system operating data stored in the hidden area, the system operating data stored in the hidden area is overwritten onto the data area.

4. A mobile communication terminal having a nonvolatile memory for reconstruction of system operating data, the mobile communication terminal comprising:
an embedded file system(EFS) area including a data area storing a first system operating data and a hidden area storing a second system operating data and allowing only a read access; and
a binary area storing an algorithm that periodically compares the first system operating data stored in the data area and the second system operating data stored in the hidden area.

5. The mobile communication terminal of claim 4, wherein the data area allows both a read access and a write access.

6. The mobile communication terminal of claim 4, wherein if the first system operating data stored in the data area is different from the second system operating data stored in the hidden area, the system operating data stored in the hidden area is overwritten onto the data area.

7. A method for reconstructing system operating data in a mobile communication terminal, the method comprising the steps of:
allocating a hidden area in a nonvolatile memory;
storing system operating data in a data area and in the hidden area; and
periodically determining whether the system operating data stored in the data area is substantially the same as the system operating data stored in the hidden area.

8. The method of claim 7, further comprising the step of overwriting the system operating data stored in the hidden area onto the data area, if the system operating data stored in the EFS area is different from the system operating data stored in the hidden area.

9. The method of claim 7, wherein the hidden area allows only a read access.

10. The method of claim 7, wherein the data area allows both a read access and a write access.
